(19) United States
(12) Patent Application Publication
(10) Pub. No.: US 2006/0237355 A1
(43) Pub. Date: Oct. 26, 2006

(54) Bottom-tabbed beverage-brewing filter, filter dispenser and method

(76) Inventor: Kitty Lee Knapp, Mokena, IL (US)

Correspondence Address: JOAN I. NOREK,;THE LAW OFFICE OF JOAN I. NOREK, 19 N. GREEN STREET, CHICAGO, IL, 60607, US

(21) Appl. No.: 11/113,207

(22) Filed: Apr. 25, 2005

(51) Int. Cl. B01D 24/00

(52) U.S. Cl. 210/323.1; 210/473; 99/298; 222/189.06; 99/485

(57) ABSTRACT

A disposable beverage filter, for example a disposable coffee filter, has a tab affixed to its bottom section, providing a finger-grip apart from the body of the filter sheet, and permitting the filter to be lifted from a conventional nested stack of filters without touching the body of the filter sheet. This bottom-tabbed filter provides a free section for gripping with working the edge of the filter sheet free from the edges of adjacent filters. A nested stack of such bottom-tabbed filters are dispensed by a beverage-filter dispenser having a nested stack of bottom-tabbed filter sheets disposed bottom-side up in a container having a slitted top or narrow access opening for ready access to the tab of the upper-most filter sheet. The filter sheet is simply drawn out through the slitted top by its tab. The drawing motion, whereby the filter sheet is being pulled through a narrow substantially centered opening, both lifts up the filter sheet and starts collapsing it along a line substantially normal to its bottom center. There is no pull on the filter sheets below the upper-most filter and it has been seen that there is no tendency whatsoever of these adjacent filter sheets to follow or otherwise cling to the single sheet being extracted.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to beverage-brewing filters, particularly side-fluted basket-shaped disposable filters known as coffee filters, and dispensers therefor. More particularly, the present invention relates to disposable filter papers sold for, and used as, filtering liners for coffee makers that have basket ground coffee beans holders.

Automatic drip coffee makers are commonly used in the home and commercially for brewing coffee. Such coffee makers usually include a water-heating chamber and a spout or discharge outlet through which the heated water is slowly discharged or dripped onto ground coffee beans. The ground coffee beans are typically held in a substantially flat-bottomed basket having a small bottom outlet. The heated water that is dripped into the basket steeps the ground coffee beans, and the resultant brewed coffee drips out of the basket's bottom outlet into a carafe or other container positioned below the outlet. Filter paper is used as a disposable filtering liner in such a basket. Such a filter paper prevents the ground coffee beans from flowing out of the basket through the basket's bottom outlet, so that the brewed coffee is free of coffee grounds, and no ground coffee particles escape to clog the basket's bottom opening.

The most popular paper filters for home or commercial use of such automatic drip coffee makers are disposable, or single-use, basket-shaped coffee filters. These coffee filters are almost invariably formed as basket-shaped sheets sold in multiple-sheet filter nests or stacks. In more detail, the filters each have a flat circular bottom and fluted (pleated, corrugated) sides so that it nests within the coffee-maker basket. The side flutings or pleatings, which start narrowly at the perimeter of the circular bottom and widen as they run up the side, produce the basket configuration from flat circular sheets, and provide a degree of configuration stability without rigidity.

Such a fluted basket filter is merely placed into a basket to line it without any adjustment, shaping or other manipulation to fit the filter snugly in the basket. The flat bottom of the filter covers the flat bottom of the basket, and the fluted sides of the filter will lightly rest against the sides of the basket. Ground coffee beans are dispensed (poured or spooned or the like) into the filter. Coffee maker baskets, and the filters therefor, are sized so that even when the maximum number of cups are being brewed, the proportional mound ground coffee beans will lie sufficiently below the upper edge of the filter so that grounds do not slip between the filter and the basket sides. Then the basket is positioned under the hot-water discharge outlet, and the carafe is placed below the basket. After the coffee is brewed, the basket is removed from the coffee maker, and the used filter, containing the now spent coffee grounds, is simply pulled out and discarded as an intact unit. In other words, the filter also enwraps the spent grounds.

Such start-to-finish use of paper coffee filters would not nearly be as practical as it is unless the filters were supplied at retail in fluted form, as they routinely are. Further, it would not be practical to retail such fluted filters, and it would not be practical to store such fluted filters, except nested in stacks of typically fifty or a hundred individual sheets or more. These stacks are then sold either in cardboard box container-dispenser combinations or plastic bags. Those boxes and bags occupy only a modest amount shelf space as is appropriate for such type of disposable product.

The primary impracticality seen in the use of these fluted filters is the difficulty in separating a single sheet from a nested stack of filters. The filter sheets are thin and have sufficiently rough, stick-together surfaces that the first step of extracting one filter from the box or bag or other dispenser is an irritation to the person brewing the coffee. Regardless of from which end of the stack the user is attempting to extract a single filter, the task requires touching or fingering the end filter. Such handling of a filter sheet will invariably press it further against the sheets below it, increasing their tendency to cling or stick together. Further, unless the single filter separates from the stack upon initial fingering, which seldom happens, the user must work at the edges, for instance attempting to slide the edge of the end filter away from the edges of adjacent filters to free enough of the end filter so it may be lifted from the stack.

While extracting a single filter sheet is not an impossible task, and there is no significant deleterious impact if occasionally multiple filters are used together, the irritation is a daily irritation for many consumers, and an irritation some suffer through many times a day in coffee shops, restaurants and other commercial establishments.

### BRIEF SUMMARY OF THE INVENTION

The present invention provides a filter having a tab affixed to its bottom section, providing a finger-grip apart from the body of the filter sheet, and permitting the filter to be lifted from a conventional nested stack of filters without touching the body of the filter sheet. This bottom-tabbed filter provides a free section for gripping with working the edge of the filter sheet free from the edges of adjacent filters.

The present invention also provides a nested stack of filters and a beverage-filter dispenser comprised of a nested stack of bottom-tabbed filter sheets disposed bottom-side up in a container having a slitted top or equivalent opening for ready access to the tab of the upper-most filter sheet. The filter sheet is simply drawn out through the slitted top by its tab. The drawing motion, whereby the filter sheet is being pulled through a narrow substantially centered opening, both lifts up the filter sheet and starts collapsing it along a line substantially normal to its bottom center. There is no pull on the filter sheets below the upper-most filter and it has been seen that there is no tendency whatsoever of these adjacent filter sheets to follow or otherwise cling to the single sheet being extracted.

The present invention also provides a method of extracting a filter sheet from a nested stack of filters by pulling the uppermost filter out of a dispenser by its bottom tab.

### BRIEF DESCRIPTION OF THE SEVERAL VIEWS OF THE DRAWING

FIG. 1 is an elevated side view of a bottom-tabbed beverage filter of the present invention, shown mouth facing down;

FIG. 2 is an elevated side view of the filter of FIG. 1, shown rotated clockwise about its normal axis 90 degrees;

FIG. 3 is a top plan view of the filter of FIG. 2, shown rotated counter-clockwise about 40 degrees;

FIG. 4 is an elevated side view of a bottom-tabbed beverage filter of the present invention, shown mouth facing down;

FIG. 5 is a top plan view of a bottom-tabbed beverage filter of the present invention, shown mouth facing down;

FIG. 6a, FIG. 6b and FIG. 6c, are a sequence of partially diagrammatic elevated side views of a stack of bottom-tabbed beverage filters and a filter dispenser combination of the present invention, the uppermost filter being withdrawn in the sequence from FIG. 6a through FIG. 6c;

FIG. 7 is a perspective view of a stack of bottom-tabbed beverage filters and a filter dispenser combination of the present invention, the filter stack being shown in phantom; and

FIG. 8 is a perspective view of a stack of bottom-tabbed beverage filters and a filter dispenser combination of the present invention, the dispenser being shown with its top in an inoperable open position.

### DETAILED DESCRIPTION OF THE INVENTION

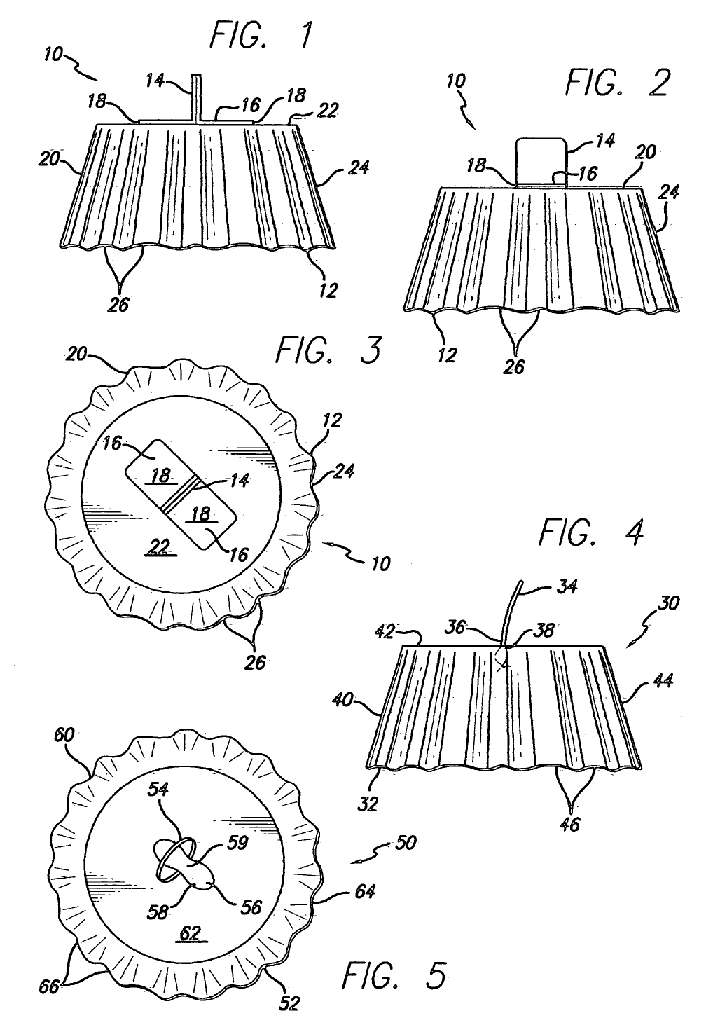

Referring now to the invention in more detail, in FIG. 1, FIG. 2 and FIG. 3 there is shown a bottom-tabbed beverage filter of the present invention, designated generally by the reference numeral 10, shown with its inlet or mouth 12 facing down. The filter 10 has a projecting tab 14 which, in the embodiment of FIG. 1, FIG. 2 and FIG. 3, is formed from an adhesive strip or member 16. In more detail, the adhesive member 16 is folded upon itself in the center to form the tab 14, and the flanking side sections or legs 18 are adhered to the filter bottom 22 of the filter body 20, leaving the tab 14 projecting up from the filter bottom 22 when the filter 10 is, as shown, placed with its mouth 12 facing downward.

The filter 10 as shown, and in preferred embodiments, has a filter body 20 that, when spread out flat, has a substantially circular profile. The filter body 20 of the filter 10 is of the type conventionally used in automatic drip coffee makers that are commonly used in the home and commercially for brewing coffee. Such coffee makers usually include a water-heating chamber and a spout or discharge outlet through which the heated water is slowly discharged or dripped onto ground coffee beans. The ground coffee beans are typically held in a filter-lined substantially flat-bottomed basket having a small bottom outlet. The heated water that is dripped into the basket steeps the ground coffee beans, and the resultant brewed coffee drips out of the basket's bottom outlet into a carafe or other container positioned below the outlet. The filter 10 of the present invention is generally used as a disposable filtering liner in such a basket. The filter 10 of the present invention, when placed into such a coffee-maker basket (not shown) prevents the ground coffee beans from flowing out of the basket through the basket's bottom outlet, so that the brewed coffee is free of coffee grounds, and no ground coffee particles escape to clog the basket's bottom opening.

The filter 10 as shown, and in preferred embodiments, is a disposable, or single-use, basket-shaped coffee filter. The filter body 20 as shown, and in preferred embodiments, is (in the manner conventionally and almost invariably) formed as a basket-shaped sheet that can be conventionally sold in multiple-sheet filter nests or stacks. In more detail, the filter body 20 has a flat circular filter bottom 22 and a continuous fluted (pleated, corrugated) side 24 so that it nests within the coffee-maker basket. The side flutings or pleatings 26, which start narrowly at the perimeter of the circular bottom 22 and widen as they run up the side 24 terminating at the filter mouth 12, produce the basket configuration from a flat circular sheet, and provide a degree of configuration stability without rigidity.

Such a fluted basket filter 10 is merely placed into a basket to line it without any adjustment, shaping or other manipulation to FIG. t the filter 10 snugly in the basket. The flat bottom 22 of the filter 10 covers the flat bottom of the basket, and the fluted continuous side 24 of the filter 10 will lightly rest against the side of the basket. Ground coffee beans are dispensed (poured or spooned or the like) into the mouth 12 filter 10.

The primary impracticality seen in the use of conventional fluted filters, namely the difficulty in separating a single sheet from a nested stack of filters, is eliminated by the present invention. The filter sheet body 20 of the filter 10 of the present invention is, as conventionally known, thin and has a sufficiently rough, stick-together surface that the first step of extracting the filter 10 from the box or bag or other dispenser would, except for features of the present invention, be an irritation to the person brewing the coffee. Unlike conventional fluted coffee filters, the filter 10 has the projecting tab 14.

The tab 14 as shown in FIG. 1, FIG. 2 and FIG. 3, and in preferred embodiments of the invention, is positioned substantially centered on the filter bottom 22. As shown, the tab 14 projects up about ½ inch and is about 1 inch wide. When formed from an adhesive member 16 in the form of a strip as shown, the adhesive member 16 can conveniently be about 3 inches long and 1 inch wide, providing as shown the projecting tab 14 that is about ½ inch tall and 1 inch wide, securely affixed to the filter bottom 22 by the flanking legs 18 that are each 1 inch long and 1 inch wide. Since the tab 14 is the folded middle section of the adhesive member 16, when multiple filters are placed in nested stacks, each tab (such as the tab 14 of filter 10) will fold down upon one or the other of the flanking legs 18 of the adhesive member 16, except the tab of the top-most filter of a mouth-down stack which will instead project up.

The bottom tab of the filter of the present invention need not be formed with an adhesive strip such as the adhesive member 16 of the filter 10 shown in FIG. 1, FIG. 2 and FIG. 3. In FIG. 4 there is shown another embodiment of the present invention, namely a filter 30, shown with its mouth 32 facing down. The filter 30 also is comprised of a filter body 40 having a flat and substantially circular filter bottom 42 and a continuous perimeter side 44 with side flutings 46 flaring down from the filter bottom 42. Projecting up from the filter bottom 42 is a tab 34 which, as shown, is the projecting end of a narrow string or light cord 36. As shown in phantom in FIG. 4, the string 36 is threaded through the filter bottom 42 from the inside out, and a knot 38 or other stop member affixes the tab 34 to the filter bottom 42. Again, the primary impracticality seen in the use of conventional fluted filters, namely the difficulty in separating a single sheet from a nested stack of filters, is eliminated. The filter sheet body 40 of the filter 30 of the present invention is, as conventionally known, thin and has a sufficiently rough, stick-together surface that the first step of extracting the filter 30 from a box or bag or other dispenser in which filters such as filter 30 are held in a nested stack would, except for features of the present invention, be an irritation to the person brewing the coffee. Unlike conventional fluted coffee filters, the filter 30 has the projecting tab 34.

The tab 34 as shown in FIG. 4, and in preferred embodiments of the invention, is positioned substantially centered on the filter bottom 42. As shown, the tab 34 projects up about ½ inch and is about 1/16 inch wide. When formed from a string 36 threaded through the filter bottom 42 with a knot 38 holding the tab 34 affixed to the filter bottom 42, the string 36 can conveniently be about ¾ or 1 inch long when unknotted, providing as shown the projecting tab 34 that is about ½ inch tall and of negligible width, securely affixed to the filter bottom 42 by the knot 38. Since the tab 34 is a slender string that emerges from the filter bottom 42, when multiple filters such as FIG. 2 are placed in nested stacks, each tab (such as the tab 34 of filter 30) will fold or lie down upon the filter bottom 42, except the tab of the top-most filter of a mouth-down stack, which will instead at least be loose, and if sufficiently stiff will have at least a tendency to project up.

In FIG. 5 there is shown another embodiment of the present invention, namely a filter 50, shown with its mouth 52 facing down. The filter 50 also is comprised of a filter body 60 having a flat and substantially circular filter bottom 62 and a continuous perimeter side 64 with side flutings 66 flaring down from the filter bottom 62. Projecting up from the filter bottom 62 is a tab 54 which, as shown, is a projecting loop or ring formed of a continuous circular band formed of plastic or other lightweight, possibly pliable semi-pliable, innocuous material. As shown in FIG. 5, the looped tab 54 is held by an adhesive member 56 which, as shown, has leg sections 58 flanking a narrow neck or middle region 59 under which the tab 54 passes. Again the primary impracticality seen in the use of conventional fluted filters, namely the difficulty in separating a single shee from a nested stack of filters, is eliminated. The filter sheet body 60 of the filter 50 of the present invention is, as conventionally known, thin and has a sufficiently rought, stick-together surface that the first step of extracting the filter 50 from a box or bag or other dispenser in which filters such as filter 50 are held in a nested stack would, except for features of the present invention, be an irritation to the person brewing the coffee. Unlike conventional fluted coffee filters, the filter 50 has the projecting tab 54.

The tab 54 as shown in FIG. 5, and in preferred embodiments of the invention, is positioned substantially centered on the filter bottom 62. As shown, the tab 54 projects up about ½ inch and is from about ½ inch to about ⅝ inch in diameter. When formed as a single piece, continuous ring, with an adhesive member 56 holding it affixed to the filter bottom 62, the tab 54 provides as shown the projecting loop that is about ½ inch tall and about ¼ of an inch in width at its upper end, securely affixed to the filter bottom 62 by the adhesive member 56. Since the tab 54 is a ring held along a short section under the adhesive member 56, when multiple filters such as FIG. 3 are placed in nested stacks, each tab such as the tab 54 of filter 50 will fold or lie down upon the filter bottom 62, except the tab of the top-most filter of a mouth-down stack which will instead at least be loose, and if sufficiently flexible or resilient so that there is little to no rotation of the tab 54 within the adhesive member 56 when folded down, the tab 54 will have at least a tendency to project up.

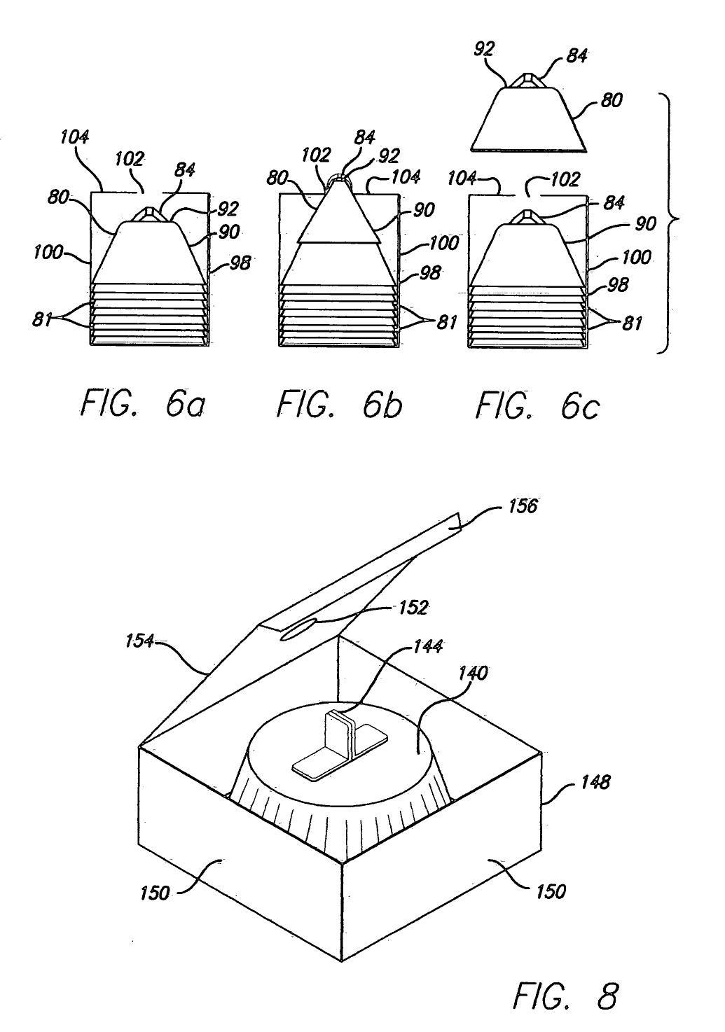

Referring now to the FIG. 6 series of drawings, there is shown in the partially-diagrammatic sequence of FIG. 6a, FIG. 6b and FIG. 6c some of the dynamics seen in the removal of a beverage filter 80 from a dispenser 98. As seen in FIG. 6a, a dispenser 98 holds a nested stack of basket-shaped filters 81, each of which has a filter body 90 and a tab 84 affixed to the bottom 92 of the filter body 90, substantially centered on the bottom 92. The dispenser 98 has substantially upright vertical sides 100. The edges of the filters 81, namely the edges of the continuous side 94 of the filters 81, are closely adjacent to, or abutting the sides 100. The dispenser 98 has a narrow opening 102 in the center of its top wall 104. As the filter 80, which is the upper-most filter in the mouth-down, or upside down, stack is lifted by its tab 84, it is lifted away from the stack and starts to collapse as it is drawn through the narrow opening 102, as seen best in FIG. 6b. The filters 81 below the filter 80 in the stack will not cling to the filter 80 sufficiently to follow it for multiple reasons. First, when the tab 84 of the filter 80 is first grasped with the user's finger tips, the finger pressure is applied solely to the tab 84 and not to any part of the filter body 90, so there is no urging of the filter 80 into greater frictional engagement with any of the filters 81 below it in the stack. Second, the collapsing of the filter 80 inward, towards the center of the dispenser 98, moves its edges away from the sides 100 of the dispenser 98, while the edges of the filters 81 remain close to, or in contact with, the sides 100, providing frictional resistance against upward movement. Third, the upward pull on the tab 84 pulls only the filter 80 upward, and the filters 81 below it sufficiently cling to one another to provide a resistance to any tendency to follow the filter 80, which resistance is further enhanced by the collapsing of the filter 80; for one or more filters 81 below the filter 80 to follow the filter 80 more than a slight distance upward, they would need to collapse within the increasingly narrowing umbrella of the filter 80, and that has not been seen to occur. It is believed that the combination of the absence of an upward pull through the narrow opening 102, which is being exerted on only filter 80, together with the inertia of the bulk and their frictional engagement or clinging one to the other, overcomes the clinging of any of the filters 81 to the filter 80 as it rides up, collapsing and sliding through the narrow opening 102. As seen repeatedly in the use of the present invention, the end filter, such as the filter 80 shown, slides over and away from the rest of the stack as it collapses through the opening 102. As shown in FIG. 6c, when the filter 80 is completely free of the dispenser 98, it begins to spring back into its original basket-shaped configuration.

The dynamics of the removal of the filter 80 from a stack of filters 81 in the dispenser 98 having a narrow, substantially centered top opening 102 differ sharply from the removal of a conventional disposable basket shaped beverage filter. As mentioned above, regardless of from which end of the conventional filter stack the user is attempting to extract a single filter, the task requires touching or fingering the end filter. In contrast, in the present invention, the end filter, such as the filter 80 of FIG. 6, only the tab 84 is touched when the filter 80 is being removed, and the filter body 90 is not handled in any way. Therefore instead of the handling of a conventional filter sheet that will invariably press it further against the sheets below it, increasing their tendency to cling or stick together, the tab 84 is a component that usually will project up from the filter body 90. Further, unless the single filter of a conventional stack of filters separates from the stack upon initial fingering, which seldom happens, the user must work at the edges, for instance attempting to slide the edge of the end filter away from the edges of adjacent filters to free enough of the end filter so it may be lifted from the stack. The use of the tab 84 to lift the filter 80 away from the stack of filters 81 completely eliminates any fingering of the filter edges.

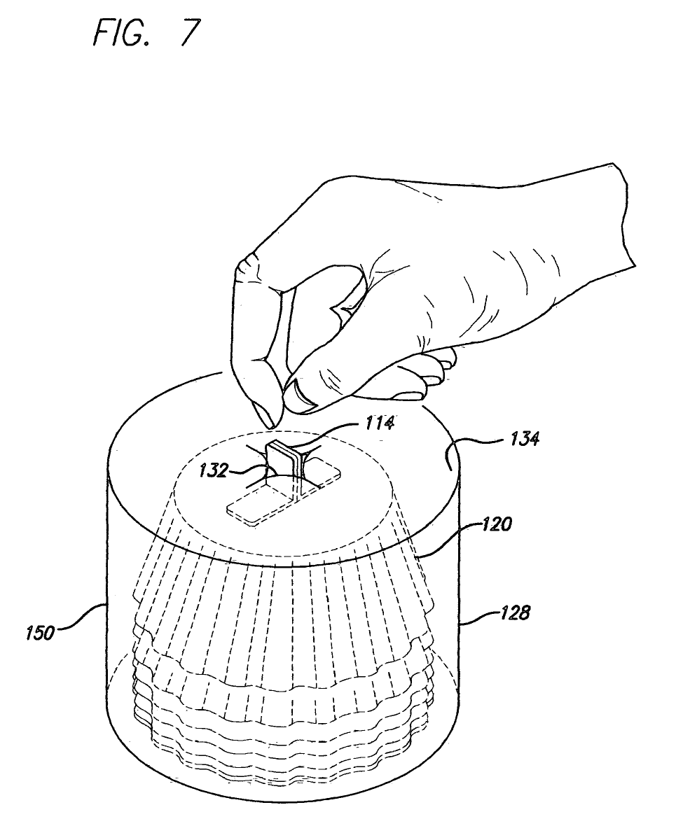

Referring now to FIG. 7, there is shown a filter 110 about to be grabbed by its tab 114 which projects toward, if not through, a slitted opening 132 in the top wall 134 of a dispenser 128. As seen in FIG. 7, the opening 132 is formed by two cuts or slits that cross each other at about the center of the top wall 134, forming a sufficiently narrow opening to collapse the filter sheet body 120 as it trails the tab 114 through the opening 132. As shown in FIG. 7, the dispenser 128 is columnar shape, that is, having a circular horizontal profile with a continuous upright vertical wall 130.

Referring now to FIG. 8, there is shown a filter 140 upper-most in an inverted stack of bottom-tabbed filter papers, with its tab 144 which projects upward, in a dispenser 148 that has a sufficiently narrow opening 152 in the top wall 154. As seen in FIG. 8, the opening 152 is formed as a substantially centered oval aperture, which optionally could be covered by plastic film slit from side to side. With or without a film covering, the opening 152 is a sufficiently narrow opening to collapse the filter sheet body 146 as it trails the tab 144 through the opening 152. As shown in FIG. 8, the dispenser 148, is box shaped, that is, having a square horizontal profile with four upright vertical walls 150. The top wall 154 is connected to the vertical rear wall 150, and further includes a front flap 156 which can be tucked into the front of the dispenser when the top wall 154 is closed. As shown open, it is seen to be a conventional filter package/dispenser combination, differing from the conventional only as to its narrow opening 152, and of course the fact that it holds bottom-tabbed disposable coffee (or beverage) filters. The dispenser 148 can be reused by inserting a replacement stack of bottom-tabbed filters. Alternatively, the dispenser 148 could be discarded when the filters are depleted.

A dispenser of the present invention can be formed as a disposable container, and in fact can be formed as a container that cannot be opened for refilling. On the other hand, a dispenser of the present invention can be formed of durable material suitable for extended use or refilling by replacement of the stack of nested bottom-tabbed filter papers whenever the stack is depleted.

The bottom-tabbed filter papers of the present invention otherwise are formed and used as conventional coffee filters. As noted above, coffee maker baskets, and the filters therefor, are sized so that even when the maximum number of cups are being brewed, the proportional mound ground coffee beans will lie sufficiently below the upper edge of the filter so that grounds do not slip between the filter and the basket sides. Then the basket is positioned under the hot-water discharge outlet, and the carafe is placed below the basket. After the coffee is brewed, the basket is removed from the coffee maker, and the used filter, containing the now spent coffee grounds, is simply pulled out and discarded as an intact unit. In other words, the filter also enwraps the spent grounds. The same use applies to the bottom-tabbed filters of the present invention. The tabs do not interfere in any manner with such normal use, and if the tabs are reversibly affixed, that is, affixed to the bottoms of the filter sheet body in such a manner that they can be removed without tearing the filter body, they may be removed before placing the filter body in the coffee maker basket.

The tab component of a filter of the present invention is affixed to the bottom of the filter sheet body, and is at least available at the external surface of the bottom, as illustrated in FIG. 1 through FIG. 7 and as discussed above. This placement of the tab component provides access to the tab at the upper-most locus, point or position of a stack of nested filters set in a mouth-down position or state. The tab is right there, ready to be grabbed and there is no need or reason to handle the filter sheet body or the edges. Further, each of the tabs of a nested stack of bottom-tabbed filters is isolated from the other tabs. Unlike providing a tab at the edge of a filter, there is no possibility of the tabs interfering with the grasping of one of them.

The tab component of a filter of the present invention is preferably positioned substantially centered on the bottom of the filter sheet body, although the points or areas of affixation need not be placed at the center, as illustrated in FIG. 1 through FIG. 7 and as discussed above. This positional placement of the tab component provides a balanced pull when lifting a filter off a stack of nested filters. Further, although an off-center placement of the tab is not excluded from broad embodiments of the present invention, there is not seen to be any advantage of offsetting the tab.

The tab component of a filter of the present invention should preferably be of a size sufficient to facilitate or enable it being grasped between the user's thumb and a finger, such as the first finger, as illustrated in FIG. 1 through FIG. 7 and as discussed above. Such a size target is believed to be met if the distal end of the tab is at least about ⅜ or ½ inch distant from the filter sheet body when the tab is upright, and if the tab component is a ring, such target is met with a ring having a diameter of about ⅜ or ½ inch. If the tab is a string, such target is met with a string having a protruding section of about ⅜ or ½ inch in length. If the tab is a square or rectangular flap, such target is met with a flap having an upright length of about ⅜ or ½ inch, and a tab that is a flap of about ⅜ or ½ inch long and about ¾ or 1 inch wide is a preferred embodiment because it provides a very convenient element for gripping between the user's thumb and first finger. The tab component of the filter of the present invention in broad embodiment need not, however, be readily gripped by hand, and instead could be smaller and grippable with a tweezers or such type of instrument without losing all of the advantages of the present invention.

The tab component of a filter of the present invention should preferably be of a size sufficient small so that it does not interfere with the nesting of the filters into a stack for storage, nor hang down on the sides of the filters. Although such embodiments are not excluded from the broad embodiments of the present invention, there is seen no advantage in an overly long tab. A tab that is no longer than about ¾ or 1 inch high, and no wider than about 1½ or 2 inches is a preferred embodiment of the present invention, and in broader but not the broadest embodiments the tab is no longer than about 1½ or 2 inches. These are appropriate mamixums for coffee filters having 4-inch diameter bottoms.

The tab component of the present invention can be made of any innocuous material provided that such material does not unduly cling to the material of the filter sheet body.

The access opening of the dispenser of the present invention in preferred embodiment should be sufficiently narrow that the filter sheet body of the filter being extracted must collapse to at least a minor degree as it trails behind the tab component, although in broad embodiments of the present invention, an access opening that is as wide as the nested stack of filters below is not excluded, but the ability to consistently extract just a single filter from the stack will be at least somewhat compromised by such an opening. The access opening of the dispenser of the present invention in preferred embodiment should be sufficiently wide to permit the user's thumb and first finger to pass through the opening to grasp the tab of the upper most filter. The access opening therefore, in preferred embodiments, should be from about ¾ to about 4 inches wide, and more preferably from about ¾ to about 2 inches wide, or a slit in a sufficiently flexible material that is expandable to such size range upon finger pressure.

Further the bottom-tabbed filters within a stack of nested filters need not all have the same type of tab, although there is no advantage seen to having variable tabs. Further the fluting of the sides of the filters is not essential to the present invention, but instead is a conventional method of shaping basket-shaped filters.

The present invention also provides a method of extracting a filter sheet from a nested stack of filters by pulling the uppermost filter out of a dispenser through a sufficiently narrow top opening by its bottom tab, as described above.

Therefore it is seen from the drawings and descriptions above that the present invention provides a filter having a tab affixed to its bottom section, providing a finger-grip apart from the body of the filter sheet, and permitting the filter to be lifted from a conventional nested stack of filters without touching the body of the filter sheet. This bottom-tabbed filter provides a free section for gripping with working the edge of the filter sheet free from the edges of adjacent filters.

It is further seen from the drawings and the descriptions above that the present invention also provides in preferred embodiments a beverage-filter dispenser comprised of a nested stack of bottom-tabbed fluted filter sheets disposed bottom-side up in a container having a slitted top or equivalent opening for ready access to the tab of the upper-most filter sheet. The filter sheet is simply drawn out through the slitted top or narrow access opening by its tab. The drawing motion, whereby the filter sheet is being pulled through a narrow substantially centered opening, both lifts up the filter sheet and starts collapsing it along a line substantially normal to its bottom center. There is no pull on the filter sheets below the upper-most filter and it has been seen that there is no tendency whatsoever of these adjacent filter sheets to follow or otherwise cling to the single sheet being extracted.

It is well within the skill of a person in the technical field, upon becoming conversant with, or otherwise having knowledge of, the present invention, to select suitable combinations of tabs and affixation methods, filters and dispensers, and the like in view of the type of filter or dispenser being designed and/or constructed.

The above described embodiments are exemplitive, and the terminology is employed for illustration purposes and not limitation purposes. The present invention is not limited to the combinations and subcombinations illustrated herein.

I claim:

1. A disposable beverage brewing filter comprising:
a filter sheet body having a bottom; and
a tab affixed to said bottom.

2. The disposable beverage brewing filter of claim 1,
said filter sheet body having sides extending from the perimeter of said bottom, said sides and said bottom delineating a receptacle; and
said tab being affixed external of said receptacle.

3. The disposable beverage brewing filter of claim 1,
said filter sheet body having a continuous side extending from the perimeter of said bottom, said side and said bottom delineating a receptacle; and
said tab being affixed external of said receptacle.

4. The disposable beverage brewing filter of claim 1 wherein said tab is substantially centered on said bottom.

5. The disposable beverage brewing filter of claim 1 wherein said tab is of a finger-hold size.

6. The disposable beverage brewing filter of claim 1 wherein said tab is at least about ⅜ inch long.

7. The disposable beverage brewing filter of claim 1 wherein said tab is from about ⅜ to about 2 inches long.

8. The disposable beverage brewing filter of claim 1 wherein said tab is from about ½ inch to about 1 inch long, and from about ½ inch to about 1½ inch wide.

9. The disposable beverage brewing filter of claim 1 wherein said tab is a flap or a ring or a string.

10. A stack of disposable beverage filters comprised of:
a plurality of disposable beverage filters,
each filter comprised of a basket-shaped filter sheet body and a tab, said filter sheet body having a bottom and said tab affixed to said bottom, and
said plurality of disposable beverage filters being nested together in said stack.

11. The stack of disposable beverage filters of claim 10 wherein said tab is from about ⅜ inch to about 1 inch long, and from about ½ inch to about 1½ inch wide.

12. The stack of disposable beverage brewing filters of claim 10 wherein said tab is a flap or a ring or a string.

14. A disposable beverage filter dispenser comprised of:
a container having an access opening;
a stack of disposable beverage filters comprised of a plurality of disposable beverage filters, each filter comprised of a basket-shaped filter sheet body and a tab, said filter sheet body having a bottom and said tab affixed to said bottom, and said plurality of disposable beverage filters being nested together in said stack,
said stack of disposable beverage filters being disposed within said container in an tab-adjacent-access opening orientation.

15. The disposable beverage filter dispenser of claim 14 wherein said tabs are from about ⅜ inch to about 1 inch long.

16. The disposable beverage filter dispenser of claim 14 wherein said tabs are from about ⅜ inch to about 1 inch long, and from about ½ inch to about 1½inch wide.

18. The disposable beverage filter dispenser of claim 14 wherein said tabs are flaps or rings or strings.

19. A method of extracting a disposable basket-shaped beverage filter from a nested stack of disposable basket-shaped beverage filters comprising the steps of:
placing a stack of disposable basket-shaped nested beverage filters, each filter having a bottom opposite a mouth, and each filter having a tab affixed to said bottom, in a mouth-down, tab up, position;
grasping the upper most tab of said filter stack; and
lifting the upper most filter of said stack by pulling up on said tab.

20. The method of extracting a disposable basket-shaped beverage filter from a nested stack of disposable basket-shaped beverage filters of claim 19, further including the sub-steps of
placing said stack of disposable basket-shaped nested beverage filters in a dispenser having an access opening;
grasping said upper most tab of said filter stack by penetrating said access opening with a thumb and a finger and then gripping said tab between said thumb and said finger; and
then lifting the upper most filter of said filter stack by pulling said tab out through said access opening.
